(19) United States
(12) Patent Application Publication
(10) Pub. No.: US 2008/0236407 A1
(43) Pub. Date: Oct. 2, 2008

(54) Automatic nut cracker

(76) Inventor: Alexander Joseph Kalogroulis, Coulsdon (GB)

Correspondence Address: Harrington & Harrington;Curtis L. Harrington, Suite 250, 6300 State University Drive, Long Beach, CA, 90815, US

(21) Appl. No.: 11/731,302

(22) Filed: Mar. 30, 2007

(51) Int. Cl. A23N 5/00; A47J 43/26

(52) U.S. Cl. 99/486; 99/571

(57) ABSTRACT

A portable nutcracker includes a handle member and a retaining member which are fittable together and axially adjustable with respect to one another. The nutcracker includes a battery powered motor which drives an epicyclic outputting to a threaded shaft on which a ram travels linearly toward and away from an anvil on the retaining member. As a safety feature, the ram advances only when the power button is activated, and retracts automatically when the power button is released. As a power-saving feature, the nutcracker automatically powers down when the ram reaches its forward or backward limit of motion. Faster action may be achieved by adjusting the retaining member relative to the handle member to decrease the space between the ram and the anvil prior to activating the motor.

### FIELD OF THE INVENTION

The present invention relates to improved technology in the field of nutcrackers and more particularly to a hand-held, portable nutcracker which is motorized to enable a user to safely break open the shells of a variety of shapes and sizes of nuts using minimal strength and effort.

### BACKGROUND OF THE INVENTION

Numerous kinds of portable nutcrackers are conventionally available. Portability in a nutcracker is desirable for several reasons, the most notable of which is portability. Portability is important to those who sample before buying and those who are picknicking. Where a market vendor's permission is obtained beforehand, it may be beneficial for a buyer to crack open and sample different kinds of nuts prior to purchasing large quantities.

Conventional nutcrackers which are manually actuated may use leverage to transmit the power necessary to crack the shell of a nut. Similarly, conventional manual nutcrackers may utilize a threaded screw to convert hand-turning motion into axial motion to break the shell. Many other kinds of cam-action devices are commonly used in manually operated nutcrackers to convert mechanical input into the power needed to crack a nutshell.

Conventional manually-actuated nutcrackers are convenient because of their portability, but almost all manual nutcrackers require a high degree of strength for effective operation. Some manual nutcrackers require availability of a level surface on which to place the nutcracker for stability and ease of operation. Handles which may be used to actuate conventional manual nutcrackers may be easily broken off while trying to crack a tough-shelled nut because the amount of force necessary to crack the nut may exceed the strength of material of the handle.

Conversely, some manually-actuated devices consistently over-amplify the input energy so that both the nutshell and the nut kernel are often unintentionally crushed. Consequently, the kernel may be pulverized and rendered inedible. Often, unintentional crushing occurs sporadically, and variation in technique may not helpful in correcting the problem because the power mechanism may be cyclic or may be otherwise beyond the control of a user. This is highly undesirable in general, and especially so where exotic or costly nuts are at risk.

Conventional motorized nutcrackers are also available, but many of these are not portable because they require an AC power source for operation. Plug-in type motorized nutcrackers limit a user's location where they may operate the nutcracker. Many people prefer to crack nuts out-of-doors because cracking nuts usually results in scattering a certain amount of shell shards. Users who do not have access to outdoor AC power may be forced to crack their nuts inside, where clean-up is usually more difficult because of carpeting, for example. Additionally, shell shards which are overlooked after clean-up may cause injury to humans and pets if stepped on with bare feet, a situation which is more likely to occur where nuts have been shelled indoors.

A user who wishes to shell nuts outdoors using a plug-in type nutcracker may, of course, purchase an extension cord which can be connected from an AC power outlet indoors to an optimal outside location. However, this is likely to be inconvenient, may waste energy where a window or door must be used to pass the cord from indoors to outdoors, and could even be quite costly where an extraordinarily long drop cord is necessary.

Other conventionally available motorized nutcrackers are touted as portable because they lack power cords and do not require AC power for operation. Many of these, however, may be large in size to accommodate internal components capable of transmitting enough force to crack a nut. Likewise, they may be designed as heavy machines to minimize vibrational effects. While technically portable, these devices may be so large, heavy, or cumbersome that they are inconvenient to carry from place to place and are therefore not truly practical as portable devices.

Many conventionally available nutcrackers, whether manual or motorized, may present serious dangers to the user. Cyclic nutcrackers, which generally do not permit interruption by a user once activated, are potentially injurious if fingers or other objects become caught in the crushing mechanism. Spring-action nutcrackers can also result in blunt trauma or may cause shell shards to project through the air, potentially causing eye or other injury. Where projectiles are a possibility, a user may not be able to avoid injury even with safety glasses or other preventive safety measures. Finally, some manually operable nutcrackers have freely-moving parts which may dislodge during use to cause injury to a user.

What is therefore needed is a powerful, hand-held, manually-actuatable, motorized nutcracker which is both safe and easily controllable by a user. The optimal nutcracker may be used to successfully break open nutshells of a variety of thicknesses with only minimal effort by a user. The ideal nutcracker has a self-contained power source, is easily portable, and may be used virtually anywhere at any time, without regard to location or the strength of a user.

### SUMMARY OF THE INVENTION

The nutcracker of the present invention may include a handle member and an retaining member. The retaining member may be fitted and screwed onto the handle member, ideally using helical threads. The end of the handle member which is engageable with the retaining member and may include a ram which is movable toward and away from an anvil on the retaining member when the handle member and the retaining member are connected. The helical threads allow the retaining member to be axially adjustable relative to the handle member so that the space between the ram and the anvil may be varied by a user to accommodate different sizes of nuts.

The handle member may include a motor which is optimally powered by batteries, allowing the nutcracker to be completely self-contained and portable. The motor may drive an epicyclic (or planetary) drive train. When the motor is activated, energy may be input from the motor into the epicyclic drive train via a shaft which may connect the motor to a central or “sun” gear. As the sun gear rotates, it may turn a plurality of planetary gears. The planetary gears may be attached to a planet carrier such that the planet carrier rotates in the same direction as that of the sun gear during operation. Multiple stages of planetary gears may be compounded together to increase the overall gear ratio in a compact form.

A threaded output shaft may be attached to the planet carrier and may engage with a corresponding set of threads in the ram. As the planet carrier rotates, the output shaft rotates such that the ram moves linearly backward and forward along the output shaft. The direction of movement of the ram depends on the direction of rotation of the output shaft. Optimally, the range of ram movement should be about 35 mm to allow for cracking a variety of nut sizes and shapes. The ram may include a chock to prevent the ram from rotating with the output shaft when the nutcracker is being operated.

The movement of the ram in the present invention is ideally slow and controlled, thereby giving a user increased control over the ram and decreasing the possibility of user injury by impingement or by shell projectiles. Where faster nut-cracking action is desired, a user may adjust the retaining member relative to the handle member so that the ram contacts and lightly secures the nut in position against the anvil. The user may then activate the motor to cause the ram to advance toward the anvil to crack the nut. This arrangement may increase the efficiency of nut-cracking, especially where there are large numbers of nuts to be shelled, because it eliminates the travel time necessary for the ram to move from a fully retracted position to a position of light contact with the nut. Thus, the time required for cracking each nut will only be attributable to the time it takes the ram to advance from a point of light contact with the nut to a point at which the nut cracks, a distance which may roughly approximate about 4 mm, on average. Additionally, a user may be able to conserve power while cracking a thin-shelled nut by merely adjusting the handle member relative to the retaining member without activating the ram.

The epicyclic drive train may include a ring gear which may act as a slipping clutch to limit the amount of torque that can be delivered to the output shaft. The ring gear may be fixed during operation under a normal load, but will optimally begin to slip when too much torque occurs to prevent overloading the motor and other components.

The handle member may include a double-pole, double-throw (DPDT) switch for reversing the polarity of the motor so that the direction of movement of the ram may be controlled. The travel of the ram may be limited in either direction either by (1) a cam switch which may be activated when the ram is fully extended or fully retracted, or by (2) manual interruption of the motor circuit via the DPDT switch.

Ideally, the DPDT switch may have an ON position and an OFF position. When a power button on the nutcracker is activated, the DPDT switch is turned ON and adjusts the polarity of the motor so that the ram moves toward the anvil. When maximum forward movement of the ram has been reached, a transfer rod, which may be connected between the ram and the switch cam, may cause the switch cam to interrupt power to the motor to stop the ram from further advancing. Whenever the ram is not fully advanced, the user may cause the ram to automatically retract by simply releasing the power button to reverse the polarity of the motor and activate backward motion of the ram.

In the OFF position, which may be achieved by releasing the power button, the DPDT reverses the polarity of the motor so that the ram is retracted away from the anvil. Once the ram is fully retracted, the transfer rod may be used to interrupt power to the motor to stop the ram from further retracting (based on the same cam switch mechanism explained in the preceding paragraph). Additionally, if the unit has been powered down by the cam switch while the ram is in the fully extended position, the power button may simply be released to allow the ram to retract automatically.

### BRIEF DESCRIPTION OF THE DRAWINGS

The invention, its configuration, construction, and operation will be best further described in the following detailed description, taken in conjunction with the accompanying drawings in which:

FIG. 1 is a perspective view of the nutcracker of the present invention as disassembled into a handle member and an retaining member;

FIG. 2 is a perspective view of the front end of the nutcracker of FIG. 1 as assembled and illustrates a ram extending through one end of the handle member and oppositely disposed from an anvil in the retaining member;

FIG. 3 is a side view of the nutcracker of the present invention wherein the retaining member has been axially advanced onto the handle member to narrow the gap between the anvil and the ram;

FIG. 4 is a partial cutaway view of the handle member of the nutcracker of the present invention which more clearly illustrates the mechanisms by which the nutcracker operates;

FIG. 5 is a view of the switching mechanism as attached to the ram via a transfer rod;

FIG. 6 is a block diagram which illustrates a possible configuration of the components in the nutcracker;

FIG. 7 is a simplified schematic illustrating an analog realization of the operation of the nut cracker and is shown with the switches in an orientation ready for initiation of the cracking process and also at the maximum reverse limit;

FIG. 8 is a simplified schematic as seen in FIG. 7 and shown with the switches in a position which would be occupied upon some forward advance of the ram;

FIG. 9 is a simplified schematic as seen in FIGS. 7 & 8 and shown with the switches in a position which would be occupied at the most forward extent of the advance of the ram, at the moment that the forward limit switch is opened;

FIG. 10 is a simplified schematic as seen in FIGS. 7-9 and shown with the switches in a position which would be had during retraction of the ram and before the reverse limit is reached at which time the reverse limit switch would be opened as shown in FIG. 7;

FIG. 11 is a bottom view of one realization of the cam switches seen in FIG. 5;

FIG. 12 is a bottom view of the switches seen in FIG. 5 which operate against the bottom view of the cam switches seen in FIG. 11;

FIG. 13 is a plan view of a further embodiment of a nut cracker having a unitary body and eye loop anvil support;

FIG. 14 is a plan view of a further embodiment of a nut cracker having a unitary body and an anvil support having an open side; and

FIG. 15 is a plan view of one possible realization of a slip clutch utilizable with the nutcracker embodiments shown herein.

### DETAILED DESCRIPTION OF THE PREFERRED EMBODIMENT

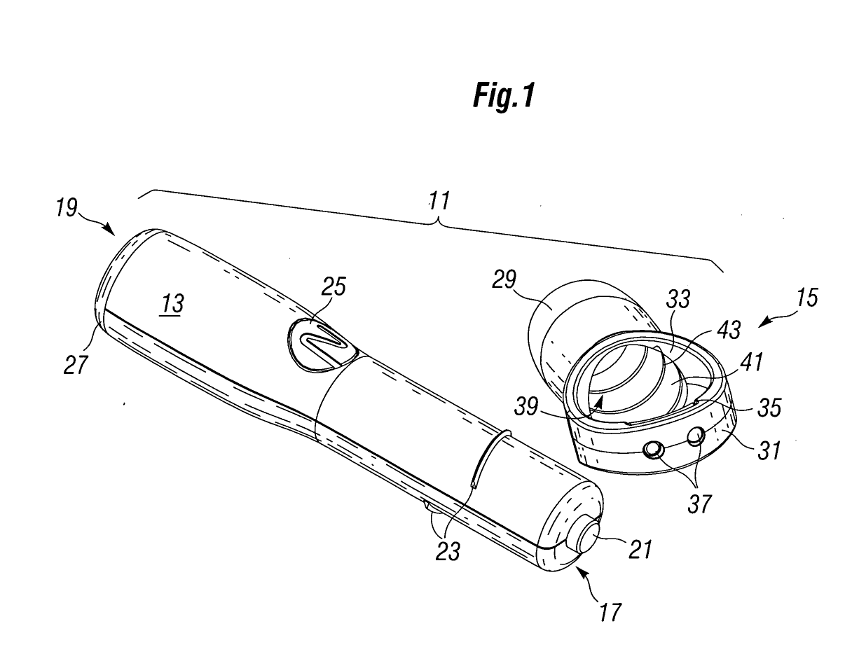

The description and operation of the invention will be best initiated with reference to FIG. 1, which is a perspective view of a nutcracker 11. FIG. 1 illustrates nutcracker 11 as having a handle member 13 and a retaining member 15. Handle member 13 has a first end 17 and a second end 19. A ram 21 is shown fully extended through first end 17 of handle member 13. Handle member 13 includes an abbreviated helical thread 23 adjacent first end 17. Situated between first end 17 and second end 19 is a power button 25. Second end 19 of handle member 13 includes a removable cap 27.

Retaining member 15 of nutcracker 11 includes a cylinder 29 and a loop 31. Loop 31 has an inner surface 33 to which an anvil 35 is mounted. Anvil 35 may be secured to loop 31 using fasteners 37. Loop 31 terminates in an opening 39 opposite anvil 35 through which the interior surface 41 of cylinder 29 is visible. The interior surface 41 of cylinder 29 includes a helical thread 43 which is compatible with the helical thread 23 on first end 17 of handle member 13. The inside diameter of cylinder 29 is slightly larger than the outside diameter of first end 17 of the handle member 13 so that the cylinder 29 of retaining member 15 can be passed onto first end 17 of handle member 13 and helical thread 23 of handle member 13 can be engaged with helical thread 43 on the interior surface 41 of cylinder 29.

Retaining member 15 may be axially adjusted to any of a range of positions along first end 17 of handle member 13 to vary the space between ram 21 and anvil 35. Given that the travel of ram 21 may be limited, the adjustability of the retaining member 15 relative to the handle member 13 effectively expands the size range of nuts that may be successfully cracked using the nutcracker 11. Although nutcracker 11 is illustrated in FIG. 1 as having a generally cylindrical shape, nutcracker 11 can be any number of different sizes or shapes which allow the retaining member 15 to be adjustably connected to handle member 13.

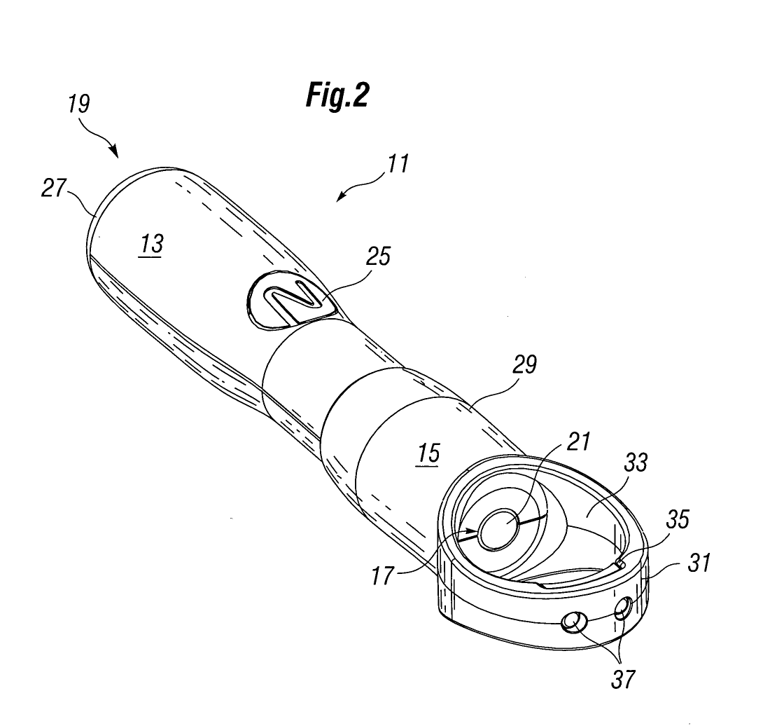

FIG. 2 is a perspective view of the front end of the nutcracker 11 of FIG. 1 as assembled. FIG. 2 illustrates the handle member 13, including removable cap 27 and power button 25, and the retaining member 15 attached to first end 17 of handle member 13 at cylinder 29. Further illustrated in FIG. 2 is loop 31, including anvil 35 and fasteners 37. Through opening 39 in loop 31, first end 17 of handle member 13 is visible, including ram 21, which is fully retracted and flush with first end 17 of handle member 13 in FIG. 2.

When a nut (not illustrated) is placed inside loop 31 and power button 25 is depressed, ram 21 advances toward anvil 35 to crack the nut. Again, given that the travel of ram 21 may be limited, a user may, where small nuts are to be cracked, adjust retaining member 15 by screwing it further onto first end 17 of handle member 13 so that the space between ram 21 and anvil 35 is decreased. This allows even small varieties of nuts to be successfully cracked using the nutcracker 11.

Furthermore, where sizeable but thin-shelled nuts are to be cracked, a nut may be placed inside loop 31, and retaining member 15 may be adjusted downward onto handle member 13 so that the nut is pressed between ram 21 and anvil 35. By continuing to advance retaining member 15 onto handle member 13, the nut may be cracked without depressing power button 25, and thus the use of power may be reserved for smaller nuts (where fully advancing retaining member 15 onto handle member 13 may not produce sufficient pressure to crack the nut) and/or tougher nuts (where motorized power may be necessary to break the nutshell).

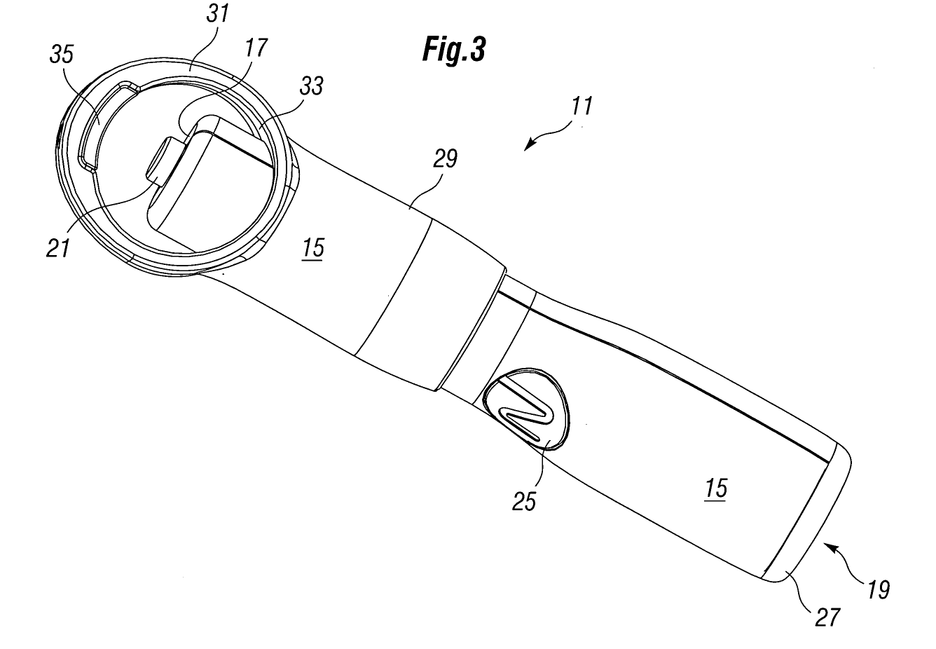

FIG. 3 is a side view of the nutcracker 11 of FIG. 2 and illustrates the retaining member 15 connected to the handle member 13 and axially advanced onto handle member 13 so that the space between anvil 35 and ram 21 is narrowed. FIG. 3 further illustrates removable cap 27 and power button 25 of handle member 13, as well as the inner surface 33 of loop 31. The ram 21 is illustrated as partially extended in FIG. 3.

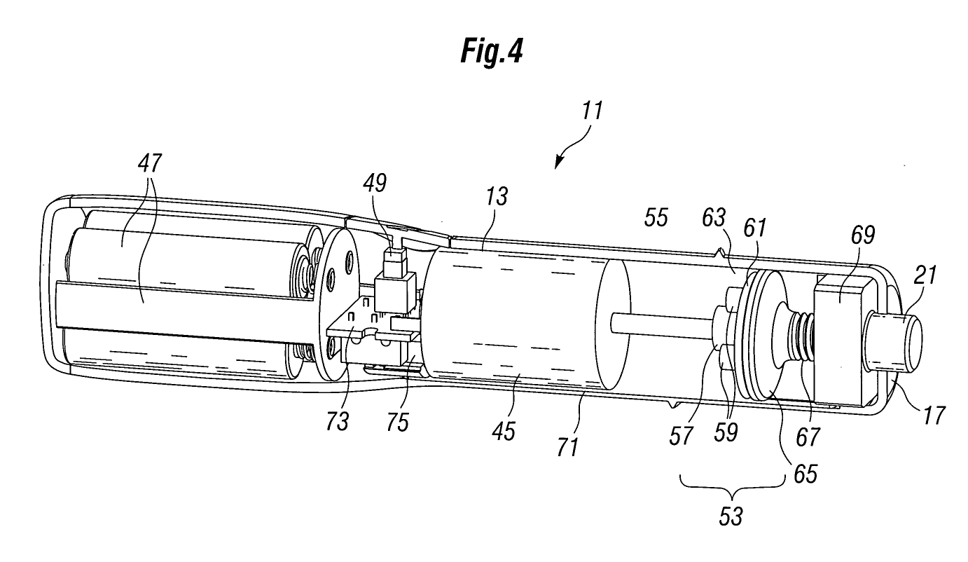

FIG. 4 is a partial cutaway view of the handle member 13 of the nutcracker 11 which more clearly illustrates the mechanisms by which the nutcracker 11 operates. Nutcracker 11 is illustrated as having a motor 45 which may be powered by a battery pack 47. Battery pack 47 may be accessed through removable cap 27 at second end 19 of handle member 13. Because nutcracker 11 is a hand-held unit that is compact in size and optimally relies only on battery power, nutcracker 11 is truly portable and can be carried and used virtually anywhere. Power button 25 controls a switch 49 which is optimally a double-pole, double-throw (DPDT) switch capable of reversing the polarity of the motor 45 especially in an analog realization.

Motor 45 has an output shaft 51 which may drive an epicyclic drive train 53 located in a gearbox 55. The epicyclic gear train may be singular or a compound of multiple stages. Output shaft 51 ideally drives a central or “sun” gear 57 which, in turn, drives a plurality of planetary gears 59. Planetary gears 59 may be mounted to a planet carrier 61. Epicyclic drive train 53 may further include a ring gear 63. Ring gear 63 is optimally fixed relative to the inner wall of gearbox 55 but may include a clutch mechanism whereby high levels of torque allow the ring gear 63 to slip relative to gearbox 55 to minimize wear and damage. Alternatively, a slipping clutch may be placed between two epicyclic stages allowing the input sun gear on the second stage to slip relative to the output carrier of the first stage.

If motor 45 rotates output shaft 51 clockwise, planetary gears 59 optimally rotate counter-clockwise. If the ring gear 63 is fixed, the rotation of planetary gears 59 causes the planetary gears 59 to revolve inside the ring gear 63 in a clockwise direction, thus rotating planet carrier 61 in a clockwise direction. If a high degree of torque occurs, a clutch mechanism will allow the ring gear 63 to slip and thus be rotated by the planetary gears 59. As a result, planet carrier 61 will stop rotating, which may help to avoid overloading the motor 45, or avoid stopping the mechanism for example.

Although ring gear 63 is illustrated here as occupying only a component of gearbox 55, it is conceivable that the entire interior of gearbox 55 could act as a ring gear and a clutch mechanism could be located between gearbox 55 and the interior wall of handle member 13. The arrangement illustrated in FIG. 4, however, may generate the least amount friction. A thrust bearing 65 may be included adjacent planet carrier 61 and may act to absorb axial load pressure to protect the epicyclic drive train 53 from being distorted, among other things.

A threaded output shaft 67 is illustrated as attached to planet carrier 61. Ram 21 is shown engaged with threaded output shaft 67 and is illustrated as including a chock 69 to keep ram 21 from rotating with threaded output shaft 67. As a result, when threaded output shaft 67 rotates in a given direction, ram 21 advances or retracts axially along threaded output shaft 67 such that the position of ram 21 varies between full retraction (wherein ram 21 is flush with first end 17 of handle member 13) and full extension (wherein ram 21 extends fully through first end 17 of handle member 13 up to chock 69. Again, given that the range of travel of ram 21 may be limited as described, a user would ideally have the option to adjust retaining member 15 relative to handle member 13 when necessary to accommodate small nuts or to conserve power while cracking thin-shelled nuts or to avoid smashing.

FIG. 4 further illustrates a transfer rod 71, which may extend between ram 21 and a circuit board 73, to which DPDT switch 49 and battery pack 47 are also connected. A cam switch 75, including an actuator 77 which operates upon switches 79 and 81 supported by the circuit board 73. The cam switch 75 may be interposed between transfer rod 71 and circuit board 73 for powering down the nutcracker 11 when the ram 21 has reached either a forward or backward limit of movement.

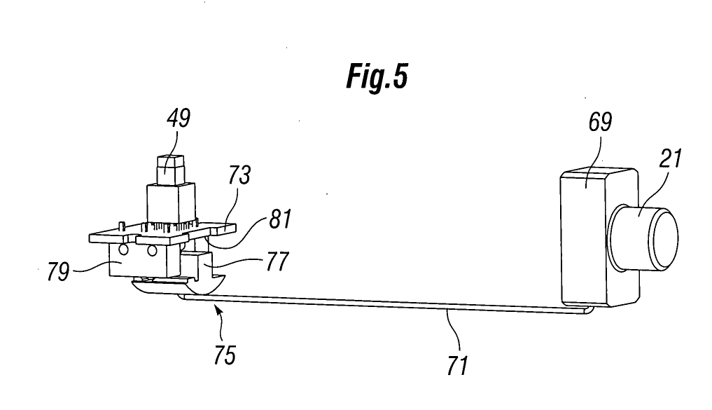

FIG. 5 is an isolated view which more clearly illustrates the relationship between ram 21 (including chock 69), transfer rod 71, and cam switch 75. Also illustrated in FIG. 5 is DPDT switch 49 as connected to circuit board 73.

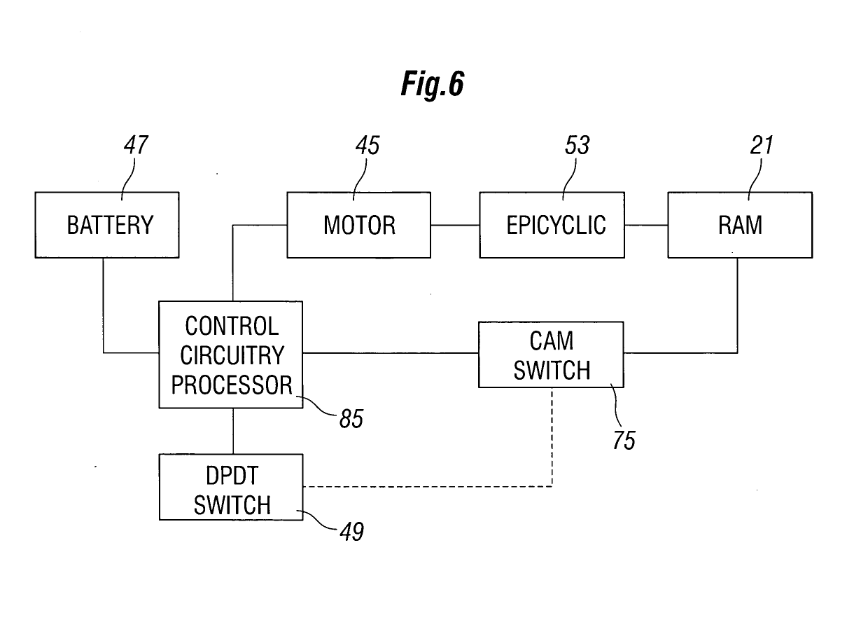

FIG. 6 is a block diagram which illustrates one potential configuration of the components inside nutcracker 11. In this configuration, DPDT switch 49 may be activated using power button 25, not illustrated in FIG. 6. Activating DPDT switch 49 turns nutcracker 11 on and activates CONTROL CIRCUITRY PROCESSOR 85. CONTROL CIRCUITRY PROCESSOR 85 can activate motor 45, which activates the epicyclic drive train 53, causing ram 21 to move forward. At the circuit level, forward movement of ram 21 might occur by the opening of a backward motion circuit, which is normally closed, and by the closing a forward motion circuit, which is normally open, so that power is delivered from the battery 47 to the motor 45.

When ram 21 reaches its forward limit of motion, transfer rod 71 activates a cam switch 85 to override the DPDT switch 49 and interrupt power to motor 45 so that ram 21 is halted and is prevented from further forward motion. Following the circuit-level example from above, cam switch 85 may re-open the forward motion circuit that was previously closed by activating the DPDT switch 49. Ram 21 is also prevented from backward motion while the power button 25 is being depressed (again, based on the circuit-level example, the backward motion circuit should remain open as long as the DPDT switch 49 is activated).

If power button 25 is released so that the DPDT switch 49 is deactivated, CONTROL CIRCUITRY PROCESSOR 85 changes the polarity of motor 45 so that ram 21 is retracted. At the circuit level, this may occur via an opening of the forward motion circuit and a closing of the backward motion circuit. As ram 21 reaches its backward limit of motion, transfer rod 71 again acts on the cam switch 77 to interrupt power to motor 45 so that ram 21 is halted and is prevented from further backward motion. Continuing to follow the circuit-level example, cam switch 77 may re-open the backward motion circuit which was previously closed by deactivating the DPDT switch 49. Ram 21 is also prevented from forward motion because the power button 25 is not being depressed (and based on the circuit-level example, the forward motion circuit should remain open when the DPDT switch 49 is not activated). A dashed control line between cam switch 75 and DPDT switch 49 is seen where the control circuitry processor 77 is minimal or absent, and where the cam switch 75 can control the operation directly by manipulating the DPDT switch 49.

In this configuration, ram 21 moves toward anvil 35 to crack a nut when power button 25 is manually depressed. When ram 21 reaches its forward limit, the nutcracker 11 turns off automatically to conserve power and to avoid undue wear on the motor 45 and other components. Because an appreciable amount of space remains between ram 21 and anvil 35 even where retaining member 15 is completely advanced onto handle member 13 and ram 21 is fully extended, the possibility of pinching injury is lessened. The space between ram 21 and anvil 35 is further preserved by the built in power-off function of the nutcracker 11. As an added safety feature, ram 21 will advance only when the power button 25 is depressed, and release of power button 25 automatically and fully retracts ram 21 and powers down nutcracker 11. This makes the nutcracker 11 both intuitive and safe to use.

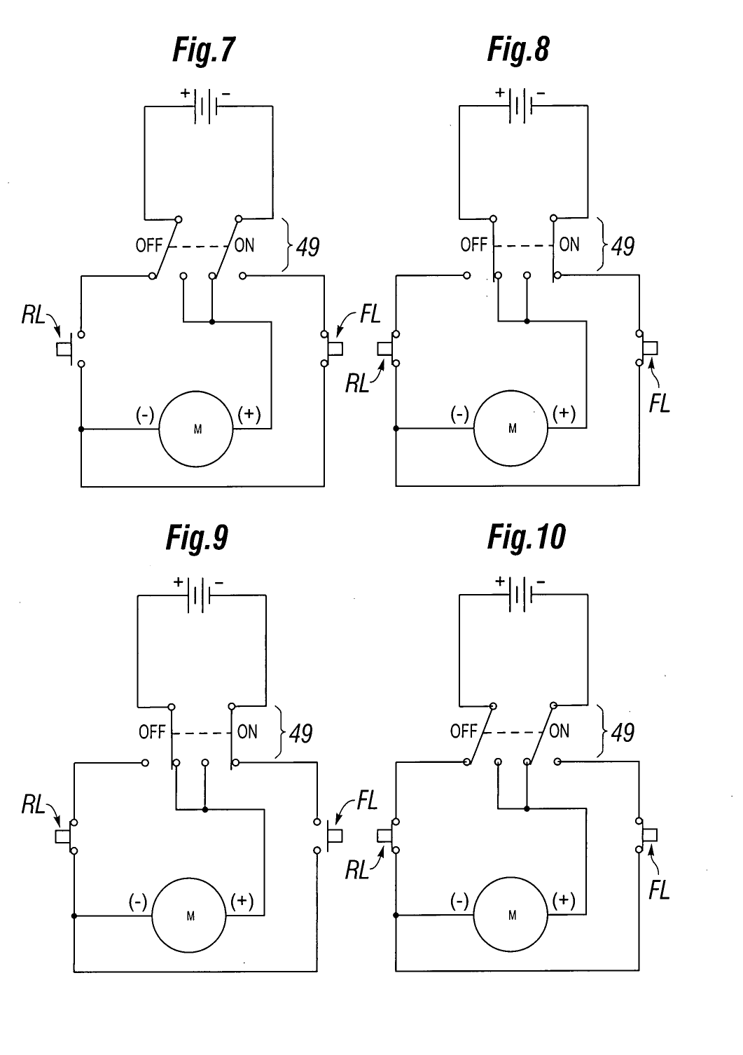

In an analog embodiment the cam switch 75 can operate with a switch 49 as a double pole double throw switch. Referring to FIG. 7 a battery is connected to a double pole double thrown switch 49 which can switch the positive pole of the battery to either direct current input of a motor M. In FIG. 7, the switch 49 is shown in its unactuated position. A reverse limit switch RL is shown in the open position, and a forward limit FL switch is shown in the closed position. In any position between a forward limit and a reverse limit, both the forward and reverse limit switches would be closed.

Thus, FIG. 7 illustrates a position where the ram is in its rearward most position, in which the user is ready to use the nut cracker 11. In this position positive power which would otherwise pass through reverse limit switch RL is interrupted and the nut cracker 11 is at rest. Upon actuation of the nut cracker 11, the user depresses switch 49 which introduces positive power into the motor M, with a return negative connection through the forward limit switch FL which has remained closed both while the nut cracker 11 is at rest and just after the ram 21 starts forward.

Referring to FIG. 8, this condition is shown. As can be seen both the Reverse limit switch RL and the forward limit switch FL are closed. The user continues to hold the switch 49 down to drive the ram 21 forward to cause the nut to be cracked. In this mid ram position, it can be seen that if the user were to inadvertently let go of switch 49, that the positive power would be introduced into the negative terminal of the motor M and it would reverse its direction and continue to reverse its direction until the reverse limit switch opened as was shown in FIG. 8.

However, in normal use, the user will continue to press the button 49 until the nut is cracked. If the user keeps the button 49 depressed at the forward limit, and if there were no forward limit switch, the motor would continue to turn. If a slip clutch were present, it would continue to slip and wear. In effect, a forward limit switch, with the presence of a slip clutch is to protect the slip clutch from excessive wear. Where a forward limit switch is present, the analog schematic for achievement of the forward limit is shown in FIG. 9, where the forward limit switch FL achieves an open circuit. The configuration seen in FIG. 9 is one where the user continues to press the switch 49, the ram 21 has traveled to its forward most extent and the forward limit switch FL is open. As can be seen, the circuit between the battery and motor is interrupted and the motor stops. Note that the reverse limit switch RL remains closed.

Referring to FIG. 10, a circuit schematic is shown at the point where the user releases the button 49. The battery positive terminal is connected to the negative terminal of the motor M, and the ram 21 moves rearwardly. In effect, the nut cracker 11 goes into reverse even if it is put down or placed on a table by a user. The ram 21 continues in reverse until the ram reaches its rearward limit where the reverse limit switch RL opens. This state is shown in FIG. 7 and represents the reset state where the nut cracker 11 is again ready to be forward actuated to crack a nut.

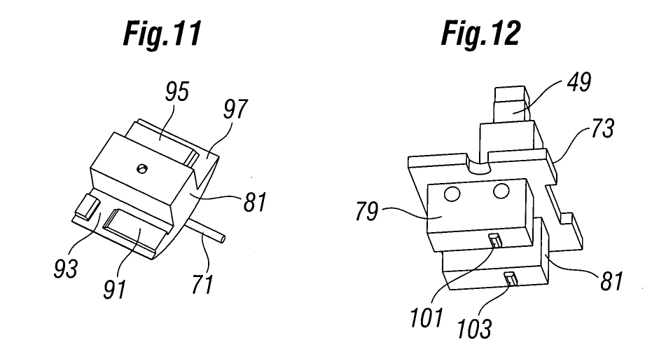

Referring to FIG. 11, a closeup view of cam switch 81 illustrates one possible configuration in which cammed surfaces can be arranged. A first raised surface 91 has a lowered surface 93 which presents itself to an open-on-release forward limit switch. At the other side of the cam switch 81, a second raised surface 95 has a lowered surface 97 which presents itself to an open-on-release reverse limit switch. The transfer rod 71 may have additional mechanisms which enable sliding “play” with regard to the cam switch 81. Referring to FIG. 12 the bottom mechanisms of the switches 79 and 81 are seem to have projecting switch elements 101 and 103, respectively.

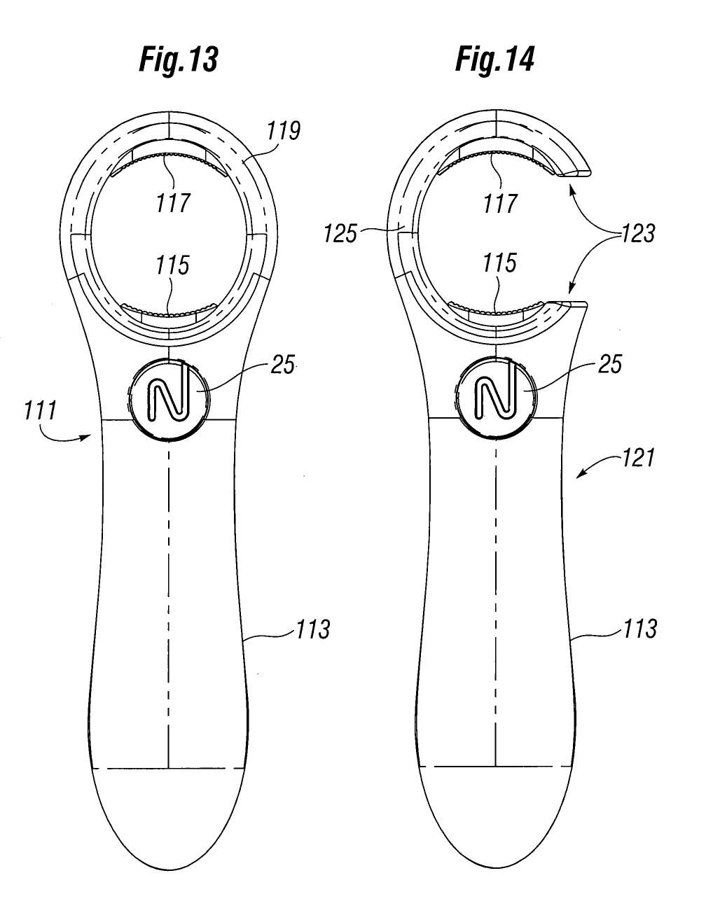

Given the path over which the ram 21 must travel, the utilization of the axial adjustable feature of the retaining member 15 can be eliminated if the path of travel of the ram 21 were to be arranged with a longer stroke. A longer stroke would mean more running time for a given pitch of ram 21 driving thread, and a longer return time, but the need for manual adjustability would be eliminated. Referring to FIG. 13, a further embodiment of a nut cracker is seen as a nut cracker 111. Nut cracker 111 includes a single piece housing 113. The ram 115 has a curved surface, and operated against an anvil 117 having a similarly matched curved surface. The design of the nut cracker 111 is such that the extent of travel of the ram 115 toward the anvil 117 can be limited, both by the internals of the device, as well as the curvatures of the ram 115 and anvil 117. The ram 115 and the anvil 117 operated within a closed eye loop structure 119 and the nuts can be loaded from either side of the eye loop.

Referring to FIG. 14 a further embodiment is seen as a nut cracker 121, with the major difference taken with respect to nut cracker 111 of FIG. 13 being the provision of an opening 123 on one side of a structure supporting the anvil 117 with respect to the ram 115. A further reinforcement of a connection arm 125 will be necessary to bear the forces occurring between the anvil 117 and the ram 115. The opening 123 enables a better view of the cracking operation and enables a more direct manipulation of a nut between the anvil 117 and the ram 115.

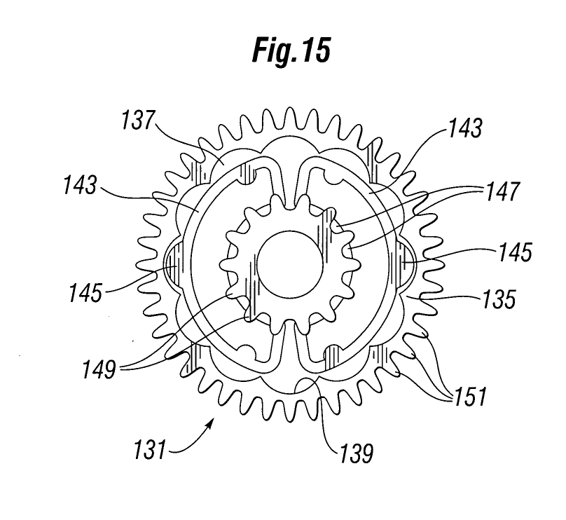

Referring to FIG. 15, a plan view of one embodiment of a slip clutch assembly 131 is seen which can be used with the nutcracker 11, 111 or 121 of the invention, as well as other uses. A housing 135 may be a sprocket or a planetary gear carrier or may have its other components operated by a planetary gear carrier such as carrier 61. Inside the housing 135 an internal space 137 having a series of concentric scalloped surfaces 139 is shown. Inside the space a fitting includes two half annular sections 143 each having an outwardly projecting engagement cam 145 which may be at a center of each of the two half annular sections 143. The two half annular sections 143 each engaged a scallop surface 139 directly in front of it. The two half annular sections 143 may join around a common ring 147 and may support a raised pinion gear 149 to either take or input gear power. The housing 135 may have teeth 151 either take or input gear power, especially in conjunction with pinion gear 149. Any force differential between the housing 135, especially from the gear teeth 151, and the includes two half annular sections 143, especially from the pinion gear 149, which exceeds the engagement of the outwardly projecting engagement cam 145 with the scallop surfaces 139 directly in front of it will cause the outwardly projecting engagement cam 145 to disengage with the scallop surface 139 directly in front of it and jump to the next most adjacent scallop surface 139. This will occur with an audible “click” noise to give an instant notification to the user that the force being put through the slip clutch has exceeded its threshold clutch value. The slip clutch assembly 131 will continue to click and slip until the power is reversed or until the obstacle preventing further action of the ram 21 is removed. The shape and orientation of the outwardly projecting engagement cam 145 with the scallop surfaces 139 is such that slippage may repeatedly occur without any significant wear or diminution of threshold value of the slip clutch assembly 131.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A nutcracker comprising:
a handle member having a first end and having a second end oppositely disposed from the first end;
a motor;
a power pack;
a ram;
a retaining member;
circuitry connecting the motor to the power pack;
and wherein the handle member houses the motor, the power pack, and the ram, the retaining member is connected to the first end of the handle member, and the motor is mechanically linked to the ram such that energization of the motor results in linear movement of the ram toward or away from the retaining member.

2. The nutcracker as recited in claim 1 and wherein the retaining member comprises:
a loop;
a connector attached to the loop for connecting the retaining member to the first end of the handle member;
an opening between the loop and the connector through which the ram and the first end of the housing are extendable when the retaining member is attached to the handle member.

3. The nutcracker as recited in claim 2 and wherein the retaining member is axially adjustable along the first end of the handle member.

4. The nutcracker as recited in claim 3 and wherein the retaining member further comprises an anvil oppositely disposed from the ram and attached to the inner surface of the loop.

5. The nutcracker as recited in claim 4 and wherein the retaining member is threadably attachable to the first end of the handle member.

6. The nutcracker recited in claim 4 and further comprising:
a shaft mechanically linking the motor to the ram;
and wherein the shaft enables translation of the ram along the length of the shaft when the motor is energized.

7. The nutcracker recited in claim 6 and wherein the ram includes a chock to prevent rotation of the ram.

8. The nutcracker recited in claim 6 and further comprising:
a manually actuatable switch, associated with the circuitry, for energizing the motor and controlling polarization of the motor.

9. The nutcracker recited in claim 8 wherein the switch is moveable between a first position associated with a first polarity of the motor and a first rotational direction of the shaft resulting in translation of the ram in a first direction generally toward the anvil, and a second position associated with a second polarity of the motor and a second rotational direction of the shaft resulting in translation of the ram in a second direction generally away from the anvil.

10. The nutcracker recited in claim 9 and further comprising:
at least one drive gear interposed between the motor and the shaft and which is drivable by the motor.

11. The nutcracker recited in claim 10 and wherein the at least one drive gear includes an epicyclic drive train comprising:
a central gear drivable by the motor;
a plurality of planetary gears drivable by the central gear;
a planet carrier onto which the plurality of planetary gears is rotatably mounted and which is rotatable by the plurality of planetary gears.

12. The nutcracker recited in claim 11 and further comprising:
an annular gear engageable with the plurality of planetary gears;
a clutch for regulating movement of the annular gear;
and wherein the clutch fixes the annular gear relative to the housing under normal operational conditions and rotates the annular gear relative to the housing when a set torque is exceeded.

13. The nutcracker recited in claim 12 and further comprising:
a thrust bearing interposed between the planet carrier and the ram for distributing axial force.

14. The nutcracker recited in claim 12 and further comprising:
a automatic switch associated with the circuitry and capable of interrupting energization of the motor by overriding the first switch;
a transfer rod extending between the ram and the automatic switch such that the automatic switch is activated by a pre-set position of the ram.
